(19) United States
(12) Patent Application Publication
(10) Pub. No.: US 2002/0181732 A1
(43) Pub. Date: Dec. 5, 2002

(54) Method of collaborative watermarking of a digital content

(75) Inventors: Reihaneh Safavi-Naini, Wollongong (AU); Philip Ogunbona, Fairy Meadow (AU); Gareth Brisbane, Coachwood Park (AU)

Correspondence Address: MOTOROLA, INC., 1303 EAST ALGONQUIN ROAD, IL01/3RD, SCHAUMBURG, IL, 60196

(73) Assignee: MOTOROLA, INC

(21) Appl. No.: 09/829,837

(22) Filed: Apr. 10, 2001

(51) Int. Cl. G06K 9/00

(52) U.S. Cl. 382/100

(57) ABSTRACT

A method (12) for collaboratively watermarking a digital content that includes portions produced by respective members (6) in a group is disclosed. A trusted authority (4) provides (16) a plurality of partial watermarks (30, 32, 40) and distributes (18) to each of the members (6) one of the plurality of partial watermarks (30, 32, 40). The members (6) watermark respective portions using the partial watermarks (30, 32, 40) to create respective watermarked portions. A combiner (8) combines the watermarked portions to produce a watermarked digital content having a watermark. A recipient (10) is able to extract the watermark from the watermarked digital content and verify that it is similar to a master watermark (28, 42).

### FIELD OF THE INVENTION

The present invention relates, in general, to a method for watermarking digital information, and more particularly, to a method for collaborative watermarking of a digital content produced by different members of a group.

### BACKGROUND ART

In the prior art, watermarking has been used for copyright protection and tamper-proofing of digital data. U.S. Pat. No. 5,905,800 describes a method and system for performing digital watermarking. In digital watermarking, a signal known as a watermark, is embedded within a digital content or data. Watermarking is also used for augmenting digital content and for including new features. Typically, the embedded watermarks are invisible or imperceptible and can only be detected or extracted by persons with special privileges. The digital content can be an image, a video clip or a 3D-image model stored in digitised form or any multimedia data.

There are two types of watermarking, fragile and robust watermarking. In fragile watermarking the watermark changes or disappears with the slightest change in the watermarked digital content. In a robust watermarking system, the embedded watermark persists even after attempts are made to remove the watermark from the digital content.

Some watermarking applications are described below. One watermarking application is for copyright protection and infringement detection. A watermark is added to a digital content to indicate ownership. Since such a watermark indicates the ownership of the content, attempts may be made to destroy or remove the watermark. Such a watermark should therefore be robust. Any attempt at removing or modifying the watermark should preferably damage the digital content as well.

Another application of watermarking is for determining the authenticity of a digital content. Such determination is necessary, for example, in a court of law or a newspaper agency for ensuring that a digital content submitted as evidence or for publication respectively has not been tempered with. Unlike copyrighted materials, digital content whose authenticity is to be ascertained is not prone to copying. There is therefore no motivation to have the watermark modified or destroyed. The watermark can be fragile in such an application. However, it is important to prevent the creation of a fraudulent watermarked digital content. Also, in this type of application, the digital content should not be illegitimately read. Only persons armed with appropriate keys should be allowed to read the digital content.

A third application of watermarking is for content enhancement. A digital watermark can be used to add useful information, such as links, references and modification history, to a digital content. Watermarking provides an efficient method of attaching additional information to a digital content without requiring additional resources.

All the above watermarking applications involve insertion of a single watermark in a digital content. They do not cater to insertion of more than one watermark to a digital content made up of works created by different members in a group. It may be necessary to include information regarding ownership rights and other details of the individual members. An example of such a digital content is multimedia data that includes a soundtrack created by one of several originators of the multimedia data. An author of the soundtrack may demand that identification of the author be included in the multimedia data before the author grants permission for others to use the multimedia data.

### SUMMARY OF THE INVENTION

According to one aspect of the invention there is provided a method for collaboratively watermarking a digital content that includes portions or copies produced by respective members in a group. The portion could be the whole digital content. Said method provides a plurality of partial keys and distributes to each of said members one of said plurality of partial keys. Said portions are then watermarked using one of said plurality of partial keys to create respective watermarked portions. Said watermarked portions are combined to produce a watermarked digital content having a watermark. Said watermark is extractable or detectable from the watermarked digital content only by using the correct verification key.

Suitably, the said plurality of partial keys are derived using said master key.

Suitably, said master key may be derived from said plurality of partial keys.

Suitably, said digital content may include digital data of one of an image signal and an audio signal.

Suitably, watermarking said portions might include watermarking said portions in a spatial domain of said portions.

Suitably, watermarking said portions might include watermarking said portions in a transform domain of said portions.

Suitably, said watermark may be fragile.

Suitably, said watermark may be robust.

### BRIEF DESCRIPTION OF THE DRAWINGS

In order that the invention may be readily understood and put into practical effect, reference will now be made to preferred embodiments as illustrated with reference to the accompanying drawings in which:

FIG. 1 is a block diagram showing a collaborative watermarking scheme;

FIG. 2 is a sequence of steps for performing collaborative watermarking in accordance with the scheme in FIG. 1;

FIG. 3 is a block diagram similar to FIG. 1, including implementation details according to a first embodiment of the present invention; and

FIG. 4 is a block diagram similar to FIG. 1, including implementation details according to a second embodiment of the invention.

### DETAILED DESCRIPTION OF PREFERRED EMBODIMENTS OF THE INVENTION

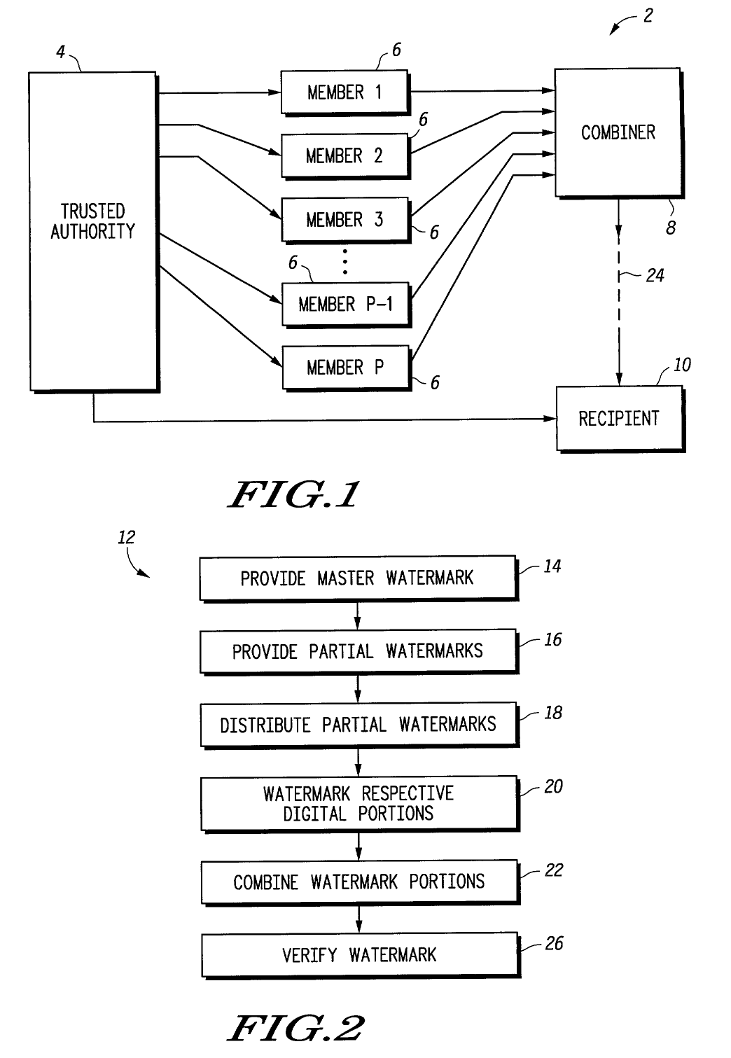

FIG. 1 shows a (p,p) collaborative watermarking scheme 2 involving a trusted authority 4, a group of members 6, a combiner 8 and a recipient 10. The notation (p,p) denotes that there are p members 6 in the group and all p members 6 need to watermark a respective portion of a digital content in order to render the digital content complete and authentic. Each respective portion need not be an original piece of work produced by a member 6. The respective portion could be arbitrarily assigned to each member 6. The digital content may include digitized data of an image signal or an audio signal.

FIG. 2 shows a sequence 12 of steps for insertion of a collaborative watermark and a sequence 13 of verifying the watermark. The insertion sequence starts with a PROVIDE MASTER KEY step 14, where the trusted authority 4 provides a master key which is used in the PROVIDE VERIFICATION KEY step 15 and the PROVIDE PARTIAL KEYS step 16. The verification key is used by a recipient 10 for verification purposes. Next, the sequence proceeds to a PROVIDE PARTIAL KEYS step 16, where the trusted authority 4 provides a plurality of partial keys. More details of how the master key and the plurality of partial keys are provided will be described later. The sequence 12 then proceeds to a DISTRIBUTE PARTIAL KEYS step 18, where the trusted authority 4 distributes to each member 6 over a secure channel one of the plurality of partial keys. Distribution over a secure channel is necessary so that a subset of the members 6, up to p−1 members 6, is not able to falsify a digital content as watermarked by the group. The sequence 12 next proceeds to a WATERMARK RESPECTIVE DIGITAL PORTIONS step 20, where the members 6 use their respective partial keys to modify a respective portion of the digital content using an encoding algorithm common to all members 6 to produce respective watermarked portions. Details of such an encoding algorithm is described later. The members 6 submit their respective watermarked portions to the combiner 8. The sequence 12 then proceeds to a COMBINE WATERMARKED PORTIONS step 22, where the combiner 8 combines the watermarked portions using a combining algorithm to produce a watermarked digital content. The watermarked digital content includes a watermark that is verifiable by the recipient 10. The watermarked digital content may be subjected to tampering as indicated by a dotted line 24 in FIG. 1. The recipient 10 of a watermarked digital content would therefore need to determine if a watermark is present in a received digital content to verify its authenticity. The recipient 10 performs such verification, sequence 13, by using the verification key received from the trusted authority 4 and a suitably designed comparison algorithm to verify the presence of the watermark in a VERIFY WATERMARK step 26.

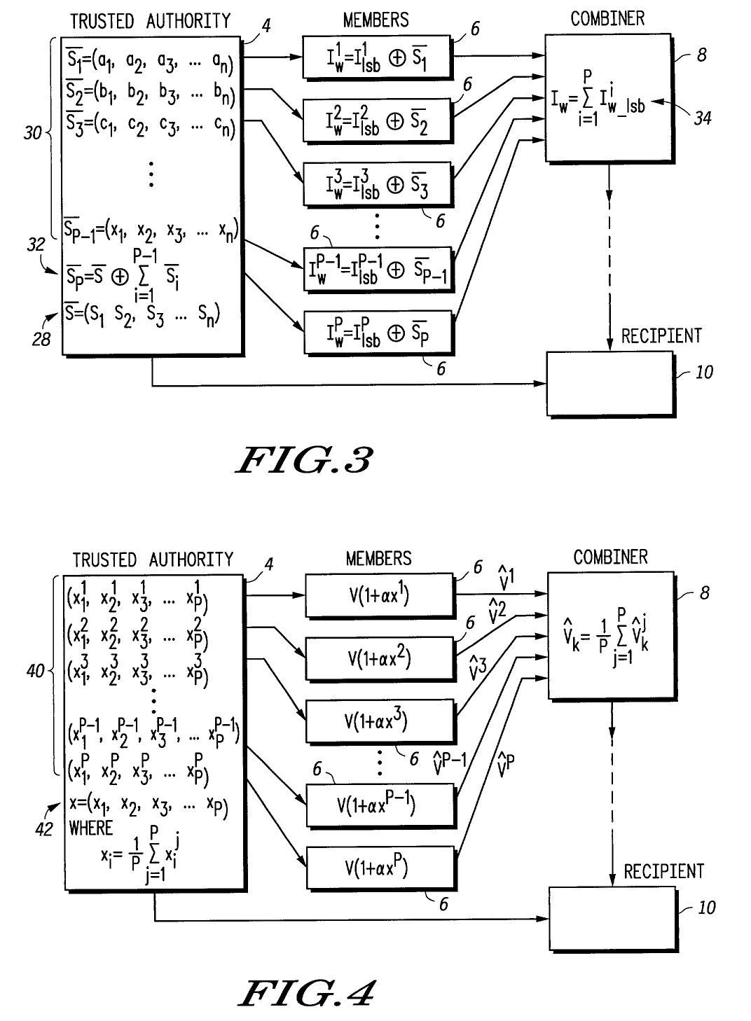

FIG. 3 describes an implementation of the collaborative watermarking scheme 2. In the PROVIDE MASTER KEY step 14, the trusted authority 4 provide a sequence of numbers, such as binary numbers, for use as a master key 28. The master key 28 is represented as:

\overline{s}=(s₁,s₂,s₃ . . . ,sₙ)

In this implementation we assume that the sequence of numbers are binary numbers.

In the PROVIDE PARTIAL KEYS step 16, the trusted authority 4 generates p−1 sequences of binary numbers for use as partial keys 30. The p−1 sequences are represented by by:

\overline{s}₁=(a₁,a₂,a₃ . . . ,aₙ)

\overline{s}₂=(b₁,b₂,b₃ . . . ,bₙ)

\overline{s}ₚ₋₁=(x₁, x₂, x₃ . . . , xₙ)

Also in the PROVIDE PARTIAL KEYS step 16, the trusted authority 4 obtains another partial key 32 by deriving a p^{th} sequence of binary numbers using the th master key 28 and the p−1 partial keys 30. The p^{th} sequence of binary numbers is given by:

$${\overline{s}}_{p} = \overline{s} ⊗ {\sum }_{i = 1}^{p - 1} {\overline{s}}_{i}$$

where ⊕ denotes bitwise exclusive-OR.

The trusted authority 4 delivers the p partial keys 30, 32 to respective members 6 in the group in the DISTRIBUTE PARTIAL KEYS step 18. In the WATERMARK RESPECTIVE DIGITAL PORTIONS step 20, the members 6 modify their respective digital portions, which in this implementation are copies of the same digital content, to create respective watermarked portions according to an encoding algorithm. One such encoding algorithm is given by:

I_{W}_{_{—}}_{lsb}ⁱ=I_{lsb}ⁱ⊕\overline{s}ᵢ

I_{W}_{_{—}}lsbⁱ is the least significant bits of the watermarked portion of member i; the other bits of the digital portion are not modified.

I_{lsb}ⁱ is the least significant bits of the digital portion of member i.

According to the above encoding algorithm, the least significant bits of the digital portions are exclusive-OR'ed with the partial keys 30, 32 (binary numbers of the sequences \overline{s}ᵢ) sent to members i.

The members 6 send their respective watermarked portions to the combiner 8. In the COMBINE WATERMARKED PORTIONS step 22, the combiner 8 combines the various watermarked portions to create the watermarked digital content 34, given by:

$${I}_{W\_lsb} = {\sum }_{i = 1}^{p} {I}_{W\_lsb}^{i}$$

where I_{w}_{_{—}}_{lsb} is the least significant bits of the combined watermarked digital content. The remaining bits of the digital content are not modified.

In addition to sending the partial keys 30, 32 to the members 6, the trusted authority 4 also sends the verification key 28 to the recipient 10. When the recipient 10 receives a watermarked digital content, the recipient verifies the presence of the watermark in the watermarked digital content by using the verification key 28.

The implementation described above results in a fragile watermarking scheme. The watermark in the watermarked digital content 34 can be easily corrupted or removed without any significant perceptual degradation of the digital content.

FIG. 4 describes a robust watermarking scheme that involves inserting a collaborative watermark in a transform domain of a digital content. The scheme is based on a spread spectrum technique.

In the PROVIDE PARTIAL KEYS step 16, the trusted authority 4 generates p sequences of real numbers for use as partial keys 40. The p sequences are represented by:

(x₁¹,x₂¹,x₃¹, . . . ,xₚ¹)

(x₁²,x₂²,x₃², . . . ,xₚ²)

(x₁^{p-1},x₂^{p-1},x₃^{p-1}, . . . ,xₚ^{p-1})

(x₁^{p},x₂^{p},x₃^{p}, . . . ,xₚ^{p})

where the notation x_{b}^{a} denotes b^{th} real number in an a^{th} sequence. Each real number is independently chosen from a normal distribution, N(0,1), where the notation N(λ,σ²)denotes a normal distribution with a mean μ and a variance σ². In the PROVIDE

MASTER KEY step 14, the trusted authority 4 provides a master key 42 by deriving it from the partial keys 40. The verification key 42 is given by:

X=(x₁,x₂,x₃, . . . ,xₚ)

where

$${x}_{i} = \frac{1}{p} {\sum }_{p} {x}_{i}^{j}$$

The trusted authority 4 delivers the p partial keys 40 to respective members 6 in the group in the DISTRIBUTE PARTIAL KEYS step 18. In the WATERMARK RESPECTIVE DIGITAL PORTIONS step 20, the members 6 transform respective portions of the digital content into a transform domain using a method such as the Discrete Cosine Transform (DCT). In the transform domain, each digital portion includes (note for See Woon: the word include is not technically correct, we would prefer “is represented as”) a number of coefficients.

The members 6 next use the received partial keys 40 with their respective digital portions in the transform domain to create respective watermarked portions. Creation of the watermarked digital content may be according to the following:

v(1+αxᵢ)

where v denotes selected coefficients of the digital portion in the transform domain,

α is a scaling factor that determines the strength of a resultant watermark in a digital portion.

The resultant watermarked portions are denoted by \hat{V}ⁱ.

The members 6 send their respective watermarked portions \hat{V}ⁱ to the combiner 8. In the COMBINE WATERMARKED PORTIONS step 22, the combiner 8 combines the various watermarked portions \hat{V}ⁱ to create the watermarked digital content. Coefficients of this watermarked digital content in the transform domain are given by an equation:

$${\hat{V}}_{k} = \frac{1}{p} {\sum }_{j = 1}^{p} {\hat{V}}_{k}^{j}$$

where

\hat{V}ₖ denotes the k^{th} coefficient of the combined watermarked digital content

\hat{V}ₖ^{j} denotes the k^{th} coefficient of the watermarked portion from member j.

The effect of the averaging in the equation above is equivalent to watermarking a digital content with a sequence of randomly generated numbers from a Gaussian distribution having a mean of zero and a variance of 1/p.

An inverse transform of the watermarked digital content produces a watermarked digital content in a spatial domain.

In addition to sending the sequences to the members 6, the trusted authority 4 also sends the verification key X to the recipient 10. When the recipient 10 receives a watermarked digital content, the recipient 10 extracts a key X′ from the watermarked digital content and compares it with the verification key X. The verification succeeds if the extracted key X′ is similar to the verification key X, as determined for example by an equation:

$$sim ( X , {X}^{′} ) = \frac{{X}^{′} X}{\sqrt{{X}^{′} X}}$$

Similarity measurement is known to those skilled in the art to be dependent on a framework of the watermarking scheme.

Advantageously, the scheme described above provides for collaborative watermarking by a group of members. Such a scheme was previously unavailable. The collusion of up to p−1 members of the group would not result in an authentic watermarked digital content from the group.

Although the invention has been described with reference to the preferred embodiments, it is to be understood that the invention is not restricted to the embodiments described herein. For example, implementations using other partial watermarks are also applicable.

We claim:

1. A method for collaboratively watermarking a digital content that includes portions produced by respective members in a group, said method comprising:
providing a plurality of partial watermarks;
distributing to each of said members one of said plurality of partial watermarks;
watermarking said portions using one of said plurality of partial watermarks to create respective watermarked portions; and
combining said watermarked portions to produce a watermarked digital content having a watermark;
wherein said watermark is extractable from the watermarked digital content and verifiable to be similar to a master watermark.

2. A method according to claim 1, wherein one of said plurality of partial watermarks is derived using said master watermark.

3. A method according to claim 2, wherein said one of said plurality of partial watermarks is derived by further using other partial watermarks of said plurality of partial watermarks.

4. A method according to claim 1, wherein said master watermark is derived from said plurality of partial watermarks.

5. A method according to claim 1, wherein said digital content includes digital data of one of an image signal and an audio signal.

6. A method according to claim 1, wherein watermarking said portions includes watermarking said portions in a spatial domain of said portions.

7. A method according to claim 1, wherein watermarking said portions includes watermarking said portions in a transform domain of said portions.

8. A method according to claim 7, wherein watermarking said portions in a transform domain of said portions includes watermarking said portions using a spread spectrum technique.

9. A method according to claim 1, wherein said watermark is fragile.

10. A method according to claim 1, wherein said watermark is robust.

11. A method for collaboratively watermarking a digital content that includes portions produced by respective members in a group, said method comprising:
providing a plurality of partial watermarks;
distributing to each of said members one of said plurality of partial watermarks;
watermarking said portions in a transform domain of said portions using one of said plurality of partial watermarks to create respective watermarked portions according to a spread spectrum technique; and
combining said watermarked portions to produce a watermarked digital content having a substantially robust watermark;
wherein said substantially robust watermark is extractable from the watermarked digital content and verifiable to be similar to a master watermark.

12. A method for collaboratively watermarking a digital content that includes portions produced by respective members in a group, said method comprising:
providing a plurality of partial watermarks;
distributing to each of said members one of said plurality of partial watermarks;
watermarking said portions using one of said plurality of partial watermarks to create respective watermarked portions; and
combining said watermarked portions to produce a watermarked digital content having a fragile watermark;
wherein said fragile watermark is extractable from the watermarked digital content and verifiable to be similar to a master watermark.
